(19) United States
(12) Patent Application Publication
(10) Pub. No.: US 2003/0173966 A1
(43) Pub. Date: Sep. 18, 2003

(54) Varactor tuned flexible interventional receiver coils

(75) Inventors: Greig C. Scott, Palo Alto, CA (US); Garry E. Gold, Los Altos, CA (US)

Correspondence Address: Henry K. Woodward, Beyer Weaver & Thomas, LLP, 590 West El Camino Real, Mountain View, CA, 94040, US

(73) Assignee: THR BOARD OF TRUSTEES OF THE LELAND STANFORD JUNIOR UNIVERSITY, Palo Alto, CA

(21) Appl. No.: 10/377,974

(22) Filed: Feb. 27, 2003

Related U.S. Application Data
(60) Provisional application No. 60/365,396, filed on Mar. 14, 2002.

(51) Int. Cl. G01V 3/00

(52) U.S. Cl. 324/322; 324/309; 324/318

(57) ABSTRACT

The tuning of an interventional receiver coil for magnetic resonance imaging signals is tuned by coupling a varactor tuned circuit with the coil and adjusting a DC voltage applied to the varactor to alter the tuning whereby the coil is tuned to the Larmor frequency of the MRI signals.

### CROSS-REFERENCES TO RELATED APPLICATIONS

This application claims priority from U.S. patent application No. 60/365,396 filed Mar. 14, 2002, which is incorporated herein for all purposes.

### BACKGROUND OF THE INVENTION

This invention relates generally to magnetic resonance imaging (MRI), and more particularly the invention relates to coils for use in interventional MRI.

Magnetic resonance imaging of joints requires high resolution and contrast to visualize small tissues. These tissues, such as the glenoid labrum and knee meniscus, are critically important for joint function. MR arthrography has been developed to help improve contrast between joint structures and injected fluid. Miniature RF coils can be placed intra-articularly to take advantage of the minimally invasive nature of this procedure and the distinction of the joint space. These coils have the potential to improve signal to noise ratio (SNR) from tissue joint MRI signals.

Intra-articular coils can utilize catheter coils, electroprobe designs, and flexible loop coils. Catheter coils are linear devices that can be placed through a single traducing sheath whose size is determined by the size of the coil itself. Electroprobe designs have the advantage of tailored sensitivity patterns and a larger field of view, however they are not a tuned coil but simply implanted conductors. The most promising design is a flexible coil that can be closed for introduction through a small diameter sheath and then opened after deployment. However, flexible coils require tuning after once deployed.

The present invention is directed to a flexible interventional RF coil and particularly to the tuning thereof for MRI signal acquisition.

### BRIEF SUMMARY OF THE INVENTION

In accordance with the invention, a coil is provided for placement interventionally for detecting MRI signals. In a preferred embodiment, the coil is flexible in design whereby the coil can be closed for fit inside a small sheath and placement interventionally, and then opened for signal reception after deployment.

A tunable circuit interconnects the coil and an output port with the tunable circuit providing enhanced signal to noise in received MRI signals. More particularly, the tunable circuit includes a varactor and a voltage source for applying a bias voltage to the varactor for controlling capacitance thereof and thereby tuning the coil for enhanced signal reception.

In accordance with a feature of the invention, the tunable circuit can be tuned either manually or automatically.

The invention and objects and features thereof will be more readily apparent from the following description and appended claims when taken with the drawings.

### BRIEF DESCRIPTION OF THE DRAWINGS

FIGS. 1A, 1B illustrate a flexible coil closed configuration and in an open configuration, respectively.

FIG. 2 is a schematic of a tunable circuit in accordance with one embodiment of the invention, interconnecting a flex coil and an output port.

FIG. 3 is a block diagram of automatic tuning circuitry for the tunable circuit of FIG. 2.

FIGS. 4A-4C are phantom images of a flexible coil which are tuned, detuned, and retuned, respectively, along with graphs of the SNR for each image.

FIG. 5 is a schematic diagram of an autotuning receiver circuit.

FIG. 6 is a plot of impedance curves for tuned, detuned, and automatically retuned coils, respectively.

### DETAILED DESCRIPTION OF THE INVENTION

FIG. 1A illustrates a flex coil in a closed configuration for insertion through a sheath for deployment, and FIG. 1B illustrates the flexible coil in an open state after deployment. It will be appreciated that the flexible coil can be opened to various configurations, each of which requires tuning for optimum reception of MRI signals.

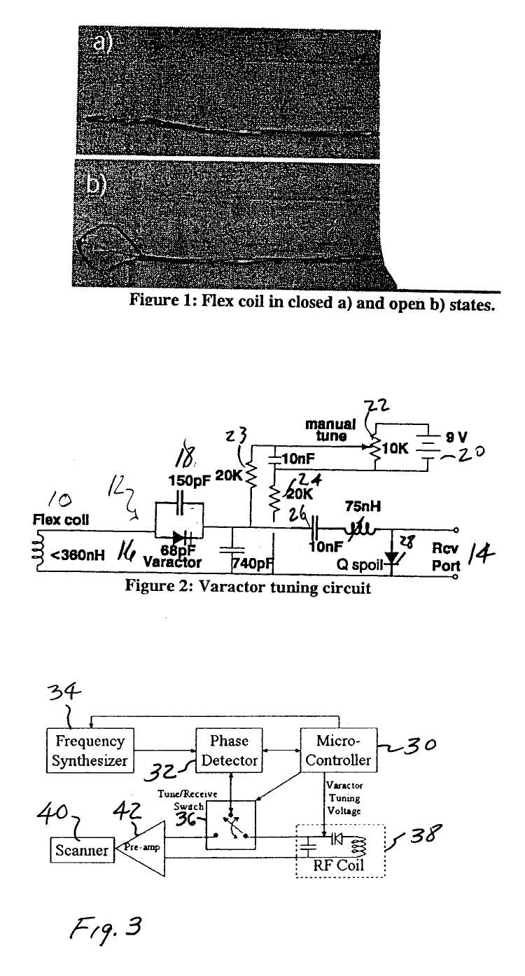

FIG. 2 is a schematic of a receiver for interventional MRI signal detection, including a flex coil 10 and a tunable circuit shown generally at 12, which interconnects flex coil 10 to a receiver port 14. The tunable circuit includes a varactor 16 connected in parallel with a capacitor 18, which provides tuning for coil 10 in maximizing signal-to-noise ratio for optimum signal detection.

A varactor is a variable capacitance diode having a pn junction with a diode depletion-layer capacitance. The depletion-layer capacitance is a function of voltage across the pn junction. Thus the varactor semiconductor diode has a strongly voltage-dependent shunt capacitance between terminals which can be used for tuning the flex coil.

Tuning of the varactor is effected with a DC tuning voltage 20 which is applied through a manually-controlled potentiometer 22 to tune the varactor. Two 20 kohm resistors 23, 24 provide RF isolation, but do not degrade the quality Q of the coil. A large DC blocking capacitor 26 (10nF) prevents the Q-spoiling PIN diode 28 at the output port from detuning the varactor.

Tests were performed in a GE 0.5T Signa SP open scanner. The tuned Q varied between 55 and 65 depending on the coil shape. Higher Q's are possible if smaller non-magnetic varactors can be placed at the coil origin. To tune the coil, rapid gradient echo images with one to two second update rates were performed. The operator interactively tuned the tuning coil until the image achieved its maximum brightness, which corresponded to on resonance.

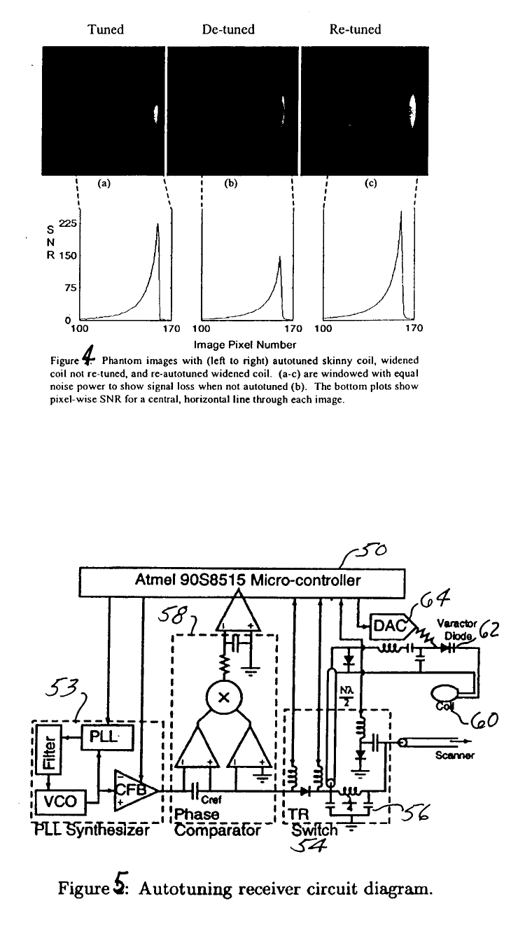

FIG. 3 is a functional block diagram of automatic tuning apparatus including a microcontroller 30, phase detector 32, and frequency synthesizer 34, which are connected through tune/receive switch 36 for use in autotuning of the RF coil 38. Once the coil is tuned for a desired Larmor frequency, switch 36 connects the coil to a scanner 40 through pre-amplifier 42. In testing the tuning, coil 38 was autotuned using the microcontroller circuitry and imaged. Then the coil shape was made narrower (by 50% into the plane direction) and an image was taken before retuning. Then, after reautotuning, a third image was acquired. The resulting images are shown in FIGS. 4A-4C. Changing the coil width by 50% (narrower and wider, respectively) we tuned the coil by −4 and 2.5 MHz. Autotuning after the shape changes created approximately 70% improvement in SNR as noted in the plots under the images in FIGS. 4A-4C. The plots show pixel-wise SNR for a central, horizontal line through each image.

FIG. 5 is a more detailed schematic of the auto tuning receiver circuits in which an ATMEL 90S8515 microcontroller is used to control the PLL synthesizer 52 composed of an MC145170-2 PLL, a mini-circuits POS-100 VCO, and an LT1227 tri-stateable current feedback amplifier. This block produces and drives a 63.9 MHz signal during tuning, and switches to 90 MHz and a high-Z state to avoid interfering with the coil 60 during signal receive mode. A PIN diode transmit/receive switch 54 provides 40 db of isolation, and along with a classic N4 impedance transformation at 56, enables appropriate impedance isolation for both tuning and receiving modes for varactor 62 and coil 60. A capacitor in parallel with varactor 62 is not shown but can be used as described above to increase total capacitance.

Phase comparator at 58 uses an AD835 high-speed multiplier with an RC lowpass filter at the output, and AD96685 ultra-fast voltage comparators to eliminate amplitude sensitivity. The varactor-diode bias voltage is generated by an LTC1257 12-bit serial DAC shown at 64, which the microcontroller steps through the tuning range while comparing the multiplier output to ground. When tuning, the impedance of a parallel resonant circuit is purely resistive on resonance, and is capacitive and inductive if resonant at frequencies below and above the target Larmor frequency, respectively. If a signal is applied at the Larmor frequency to a resonant circuit in series with a reference capacitor, their voltages will have a difference in phase of 90 degrees under tuned conditions.

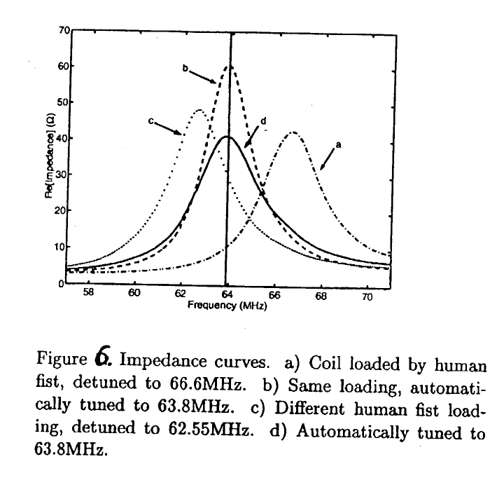

FIG. 6 shows impedance curves for the tunable receiver coil through a progression of conditions. The coil is designed to present 50 ohms when loaded, but loading also shifts the center frequency by as much as 2.8 MHz (curve a in FIG. 6). The automatic retuning circuit then retunes the impedance curve to center on 63.8 MHz, well within the 600 kHz 3 dB bandwidth of the MR signal. Curve a) is the coil loaded by a human fist and detuned to 66.6 MHz; curve b) is the same loading, but automatically tuned to 63.8 MHz; curve c) illustrates different human fist loading and detuned to 62.55 MHz; and curve d) illustrates the coil automatically tuned to 63.8 MHz.

The use of varactor tuning of MRI coils has proved to be particularly advantageous with a flexible coil which is variable in configuration both during deployment and after deployment. The coil can be readily tuned either manually or automatically for optimum SNR value.

Further, the computer control system allows the tuning to be synchronized to the dead time within an MRI pulse sequence. Also, the interventional coil can be rapidly detuned in the transmit period of an MRI sequence by varying the varactor voltage, thus further reducing the possibility of RF interaction artifacts in the final MRI image. The coil is retuned in time for the signal reception. This capability adds to the function of simple PIN diode Q spoiling to provide more robust artifact reduction and improved image quality.

While the invention has been described with reference to specific embodiments, the description is illustrative of the invention and is not to be construed as limiting the invention. For example, the phase comparison method is just one embodiment for automatic tuning. Another would use amplitude and phase comparison in the form of impedance measurement or complex ratios of received to transmitted signals when compared to a reference impedance (not just capacitor—it could be resistor). Various modifications and applications may occur to those skilled in the art without departing from the true spirit and scope of the invention as defined by the appended claims.

What is claimed is:

1. A receiver for interventional MRI signal detection comprising:
a) a coil for placement interventionally for detecting MRI signals, and
b) a tunable circuit connected with the coil for tuning, the tunable circuit including a varactor and a voltage source for applying a bias voltage to the varactor for controlling capacitance thereof and thereby enhancing signal reception.

2. The receiver as defined by claim 1 wherein the varactor is connected in parallel with a fixed capacitor to form a parallel capacitor circuit, the parallel capacitor circuit being serially connected between the coil and an output port.

3. The receiver as defined by claim 2 wherein the voltage source comprises a digital to analog converter controlled by a computer.

4. The receiver as defined by claim 2 wherein the voltage source comprises a DC voltage source connected with a variable potentiometer.

5. The receiver as defined by claim 2 and further including a diode connected across the output port for Q-spoiling and a DC blocking capacitor serially coupling the tunable circuit to the output port.

6. The receiver as defined by claim 1 and further including a diode connected across the output port for Q-spoiling and a DC blocking capacitor serially coupling the tunable circuit to the output port.

7. The receiver as defined by claim 6 wherein the coil is a flexible coil which can assume a plurality of configurations.

8. The receiver as defined by claim 1 wherein the coils is a flexible coil which can assume a plurality of configuration.

9. A method of tuning an MRI signal receiver coil comprising the steps of connecting a tunable circuit including a varactor with the coil and varying the capacitance of the varactor.

10. The method as defined by claim 9 wherein the step of varying the capacitance of the varactor includes varying DC voltage across the varactor.

11. The method as defined by claim 10 wherein the DC voltage is varied manually with a potentiometer.

12. The method as defined by claim 10 wherein the DC voltage is varied automatically with a microcontroller controlling a digital-to-analog converter.

13. The method as defined by claim 12 wherein the microcontroller controls the digital-to-analog converter in response to a phase comparison of a voltage across a reference capacitor.
